(19) United States
(12) Patent Application Publication
(10) Pub. No.: US 2008/0135769 A1
(43) Pub. Date: Jun. 12, 2008

(54) ATTENUATION CORRECTION OF PET IMAGE USING IMAGE DATA ACQUIRED WITH AN MRI SYSTEM

(76) Inventor: Bruce R. Rosen, Lexington, MA (US)

Correspondence Address: QUARLES & BRADY LLP, 411 E. WISCONSIN AVENUE, SUITE 2040, MILWAUKEE, WI, 53202-4497, US

(21) Appl. No.: 11/943,707

(22) Filed: Nov. 21, 2007

Related U.S. Application Data
(60) Provisional application No. 60/860,764, filed on Nov. 22, 2006.

(51) Int. Cl. G01T 1/161

(52) U.S. Cl. 250/363.09

(57) ABSTRACT

A method for correcting attenuation in a positron emission tomography (PET) image includes acquiring images of tissue using a magnetic resonance imaging (MRI) system. The images of tissue are acquired by the MRI system at substantially the same time that sinogram data are acquired from the PET scanner. An attenuation correction sinogram is produced from the MR images and employed to correct the acquired sinogram data. PET images are then reconstructed from the corrected sinogram data.

### CROSS-REFERENCE TO RELATED APPLICATIONS

This application claims the benefit of U.S. Provisional patent application Ser. No. 60/860,764 filed on Nov. 22, 2006, and entitled “Attenuation Correction Of PET Image Using Image Data Acquired With An MRI System”.

### BACKGROUND OF THE INVENTION

The field of the invention is positron emission tomography (PET) scanners, and particularly PET scanners used in combination with a magnetic resonance imaging (MRI) system.

Positrons are positively charged electrons which are emitted by radionuclides that have been prepared using a cyclotron or other device. These are employed as radioactive tracers called “radiopharmaceuticals” by incorporating them into substances, such as glucose or carbon dioxide. The radiopharmaceuticals are administered to a patient and become involved in biochemical or physiological processes such as blood flow; fatty acid and glucose metabolism; and protein synthesis.

As the radionuclides decay, they emit positrons. The positrons travel a very short distance before they encounter an electron, and when this occurs, they are annihilated and converted into two photons, or gamma rays. This annihilation event is characterized by two features which are pertinent to PET scanners—each gamma ray has an energy of 511 keV and the two gamma rays are directed in nearly opposite directions. An image indicative of the tissue concentration of the positron emitting radionuclide is created by determining the number of such annihilation events at each location within the field of view.

The PET scanner includes one or more rings of detectors which encircle the patient and which convert the energy of each 511 keV photon into a flash of light that is sensed by a photomultiplier tube (PMT). Coincidence detection circuits connect to the detectors and record only those photons which are detected simultaneously by two detectors located on opposite sides of the patient. The number of such simultaneous events indicates the number of positron annihilations that occurred along a line joining the two opposing detectors. Within a few minutes hundreds of million of events are recorded to indicate the number of annihilations along lines joining pairs of detectors in the ring. These numbers are employed to reconstruct an image using well known computed tomography techniques.

Positron emission tomography provides quantitative images depicting the concentration of the positron emitting substance throughout the patient. The accuracy of this quantitative measurement depends in part on the accuracy of an attenuation correction which accounts for the absorption of some of the gamma rays as they pass through the patient. The attenuation correction factors modify the sinogram which contains the number of annihilation events at each location within the field of view. There are a number of methods used to measure, or calculate the attenuation factors. These include calculating the attenuation correction; measuring attenuation correction; and a hybrid, or segmented tissue technique.

Calculated attenuation correction is employed if the object being imaged has a well defined outline, is homogeneous in electron density and has a known attenuation coefficient (e.g., water attenuating 511 keV photons with a linear attenuation coefficient of μ=0.095 cm⁻¹). In that event, the outline of the body section (e.g., the scalp in a brain scan) is drawn. Then the lines of response (LOR's) that would have been measured with a pencil beam of 511 keV photons are computed by forward projection through the outline. This LOR-set forms a sinogram of attenuation correction factors suitable for correcting the image data sinogram acquired from the emission scan. The advantage of the calculated attenuation correction is that it is noiseless. The disadvantage is that it introduces errors in cases where the assumptions of homogeneity are violated, or when the chosen outline does not coincide with the actual section. Brain scanning, with a regular shape and only a few millimeters of calverium thickness (μ≈=0.117 cm⁻¹), is generally regarded as suitable for calculated attenuation, while the thorax, with its extensive interior lung volumes, is usually not considered suitable.

Measured attenuation correction is performed by placing a source of gamma rays on the LOR, outside of the patient and measuring attenuation through the patient along this line. One measurement is made without the patient and a second measurement is made with the patient in place. By calculating the ratio of the two measurements, variations in this ratio represent the desired measured attenuation data. As described, for example, in U.S. Pat. No. 5,750,991, many different mechanisms are used to place the gamma ray source on each LOR and acquire the attenuation correction data in what is referred to as a “transmission scan”.

The major disadvantage of this measured attenuation correction technique is that unless the transmission scan has excellent statistical precision, additional noise is propagated into the corrected emission. With realistic Ge-68 source strengths and detector limitations, this translates to transmission scanning times of the order of tens of minutes, prior to administering the radiotracer for the emission scan. Furthermore, since the biodistribution of many agents (e.g., ¹⁸FDG) require times of the order of an hour to achieve the desired blood clearance, the patient must spend this intervening period motionless in the scanner in order to avoid misregistration artifacts. Finally, the technologist is obliged to take transmission scans of all axial fields that could be conceivably needed, demanding considerable prescience about the outcome of the emission scans, and increasing the discomfort of the patient on the scanner bed. The acquisition of the transmission image after the emission scan results in contamination of the transmission measurement from the activity in the field of view.

The hybrid approach, often referred to as the segmented tissue technique, combines the advantages of noiseless calculated attenuation, applied to more complex volumes such as the thorax, with lung. A short measured attenuation scan is taken, with poor statistics, but with enough contrast to delineate the major outlines of the chest wall and lung periphery. Back projection of this attenuation data forms a noisy p-image, with a histogram of μ-values peaked at 0 (air), ≈0.095 cm⁻¹ (unity density soft tissue) and ≈0.03-0.04 cm⁻¹ (lung). By thresholding, the chest wall and lung outlines on the image are formed and the interiors are filled with the accepted μ-values of 0.095 and 0.02-0.04 cm⁻¹. Forward projection through this “forced-contrast” image creates a noise free sinogram needed for attenuation correction of the subsequent emission scans. This is a valuable first-order improvement on the measured attenuation approach, but still needs enough precision to delineate irregular internal outlines, and suffers from deviations from homogeneity often seen in lung density.

More recently x-ray CT scanners have been combined with PET scanners to enable the acquisition of both x-ray attenuation data and PET data without moving the subject of the examination. As described in U.S. Pat. No. 6,631,284, which is incorporated herein by reference, this also enables the x-ray CT system to acquire x-ray attenuation data that can be transformed into PET attenuation correction data. While this enables higher resolution attenuation measurements to be made in less scan time, x-ray CT does not differentiate very well between many tissue types.

### SUMMARY OF THE INVENTION

The present invention employs an MRI system to acquire image data that is processed to produce attenuation correction data for the PET scanner. More specifically the MRI system acquires MR image data before, during and/or after the PET scan from which one or more images are reconstructed and used to produce an image which segments the different structures and tissues in the subject. Attenuation values are assigned to pixels in each segment of this image and an attenuation correction sinogram is produced by forward projecting along each LOR, or projection ray (R, θ) used by the PET scanner. This attenuation correction sinogram is subsequently employed by the PET scanner during its reconstruction process to correct the PET image in the usual fashion.

A general object of the invention is to shorten the total scan time and provide accurate attenuation corrections without need for x-ray measurements. While the MR image data may be acquired either before or after the PET data acquisition, preferably these functions are performed simultaneously. Unlike prior methods for obtaining attenuation correction data, the operation of the MRI system does not interfere with the PET scan. That is, MRI does not emit detectable particles that may be “counted” by the PET scanner.

Another object of the invention is to improve the accuracy of the PET attenuation correction. There are many different MRI pulse sequences and processing methods that can be used to differentiate between tissues having different 511 keV attenuation values. The MRI data acquisition can thus be prescribed to enable a segmented image to be produced which will differentiate the desired tissue types for the anatomy being scanned. Known attenuation values are assigned to pixels in each tissue type and the resulting attenuation map is forward projected to form the PET attenuation correction sinogram.

### BRIEF DESCRIPTION OF THE DRAWINGS

FIG. 1 is a pictorial view with parts cut away of a combination PET scanner system and MRI system which employs the present invention;

FIG. 2 is a schematic diagram of the PET scanner portion of the system of FIG. 1;

FIG. 3 is a schematic diagram of the MRI system portion of the system of FIG. 1;

FIG. 4 is a circuit block diagram of the components of a PET detector module incorporated in the PET imaging system of FIG. 2; and

FIG. 5 is a flow chart of the steps performed by the MRI system of FIG. 3 to acquire image data and produce attenuation correction values for the PET scanner of FIG. 2.

### DESCRIPTION OF THE PREFERRED EMBODIMENT

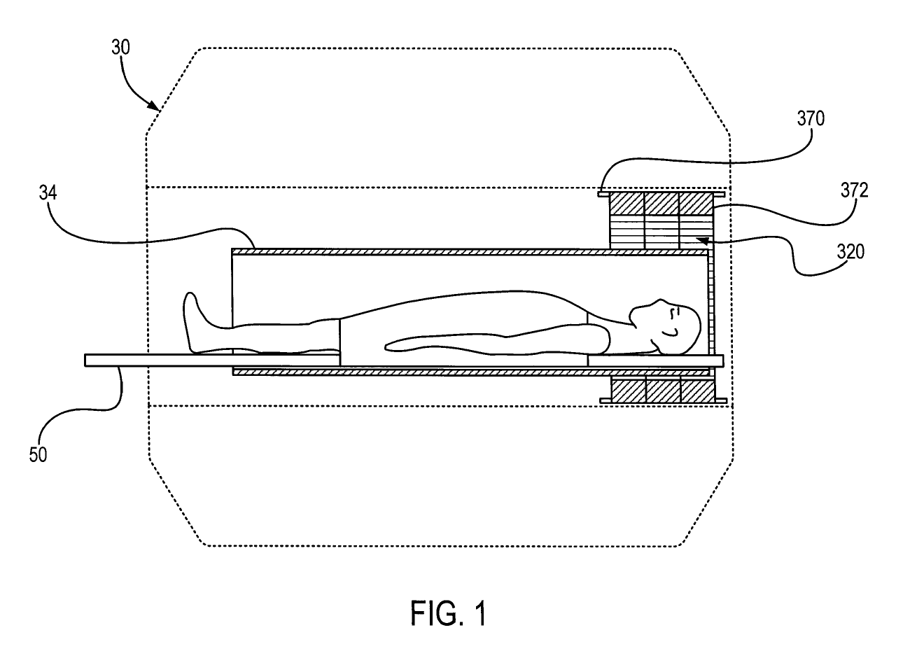

Referring to FIG. 1, the preferred embodiment of the present invention is embodied in an MRI system having a cylindrical magnet assembly 30 which receives a subject to be imaged. Disposed within the magnet assembly 30 is a plurality of PET detector rings 372 which are supported by a cylindrical PET gantry 370. Accordingly, each detector ring has an outer diameter dimensioned to be received within the geometry of the MRI scanner. In an alternate embodiment a single PET detector ring may be utilized. A patient table 50 is provided to receive a patient to be imaged. The gantry 370 is slidably mounted on the patient table 50 such that its position can be adjusted within the magnet assembly 30 by sliding it along the patient table 50. An RF coil 34 is employed to acquire MR signal data from a patient and is positioned between the PET detector rings 372 and the patient to be imaged. PET and MR data acquisitions are carried out on the patient, either simultaneously, in an interlaced or interleaved manner, or sequentially. Combination PET/MR imaging systems have been described, for example, in U.S. Pat. No. 7,218,112 and in U.S. Patent Application No. 2007/0102641, which are incorporated herein by reference. Additionally, other combination PET/MR imaging systems variations can be appreciated, such as those in which the PET and MRI systems are physically adjacent, but not fully incorporated within each other.

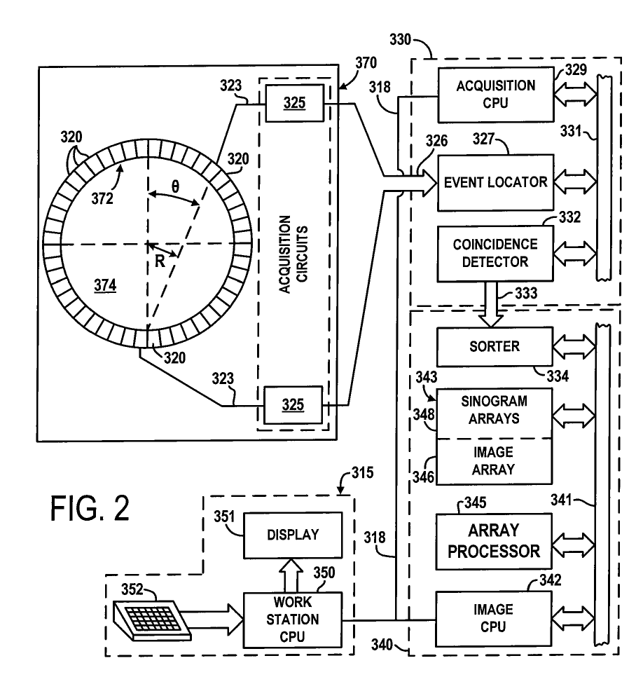

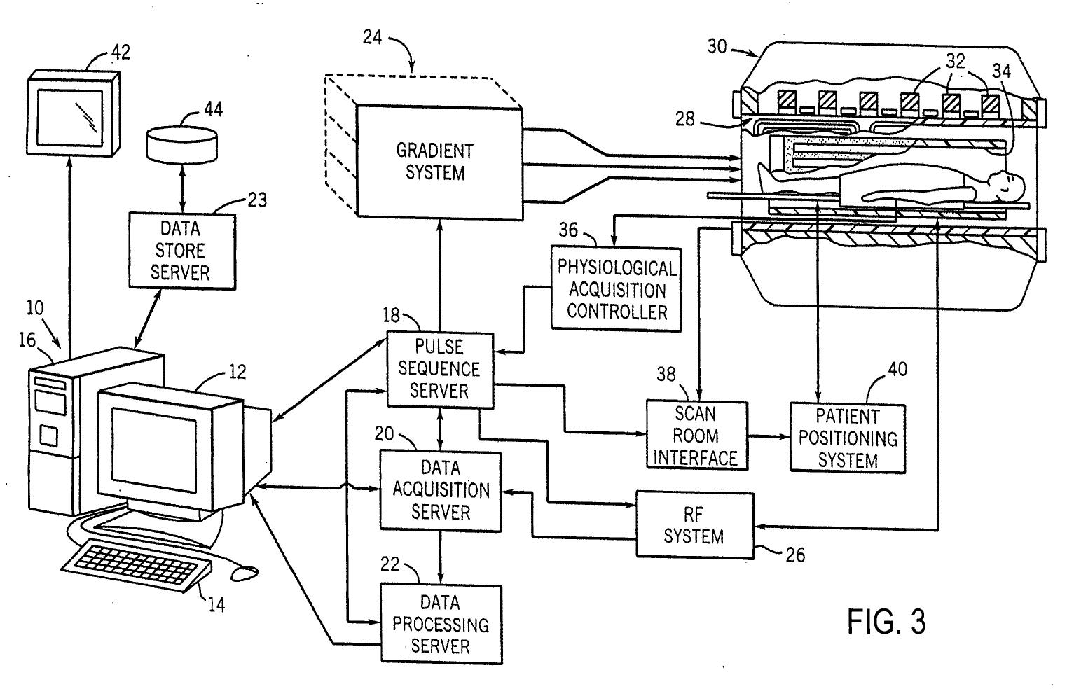

The MRI magnet assembly 30 is connected to an MRI system which is shown in more detail in FIG. 3. The detector rings 372 are connected to a PET system which is described in more detail in FIG. 2.

Referring particularly to FIG. 3, The MRI system includes a workstation 10 having a display 12 and a keyboard 14. The workstation 10 includes a processor 16 which is a commercially available programmable machine running a commercially available operating system. The workstation 10 provides the operator interface which enables scan prescriptions to be entered into the MRI system.

The workstation 10 is coupled to four servers: a pulse sequence server 18; a data acquisition server 20; a data processing server 22, and a data store server 23. In the preferred embodiment the data store server 23 is performed by the workstation processor 16 and associated disc drive interface circuitry. The server 18 is performed by separate processor and the servers 20 and 22 are combined in a single processor. The workstation 10 and each processor for the servers 18, 20 and 22 are connected to an Ethernet communications network. This network conveys data that is downloaded to the servers 18, 20 and 22 from the workstation 10, and it conveys data that is communicated between the servers.

The pulse sequence server 18 functions in response to instructions downloaded from the workstation 10 to operate a gradient system 24 and an RF system 26. Gradient waveforms necessary to perform the prescribed scan are produced and applied to the gradient system 24 which excites gradient coils in an assembly 28 to produce the magnetic field gradients Gₓ, G_{y} and G_{z} used for position encoding NMR signals. The gradient coil assembly 28 forms part of a magnet assembly 30 which includes a polarizing magnet 32 and a whole-body RF coil 34.

RF excitation waveforms are applied to the RF coil 34 by the RF system 26 to perform the prescribed magnetic resonance pulse sequence. Responsive NMR signals detected by the RF coil 34 are received by the RF system 26, amplified, demodulated, filtered and digitized under direction of commands produced by the pulse sequence server 18. The RF system 26 includes an RF transmitter for producing a wide variety of RF pulses used in MR pulse sequences. The RF transmitter is responsive to the scan prescription and direction from the pulse sequence server 18 to produce RF pulses of the desired frequency, phase and pulse amplitude waveform. The generated RF pulses may be applied to the whole body RF coil 34 or to one or more local coils or coil arrays.

The RF system 26 also includes one or more RF receiver channels. Each RF receiver channel includes an RF amplifier that amplifies the NMR signal received by the coil to which it is connected and a quadrature detector which detects and digitizes the I and Q quadrature components of the received NMR signal. The magnitude of the received NMR signal may thus be determined at any sampled point by the square root of the sum of the squares of the I and Q components:

M=\sqrt{I²+Q²},

and the phase of the received NMR signal may also be determined:

φ=tan⁻¹ Q/I.

The pulse sequence server 18 also optionally receives patient data from a physiological acquisition controller 36. The controller 36 receives signals from a number of different sensors connected to the patient, such as ECG signals from electrodes or respiratory signals from a bellows. Such signals are typically used by the pulse sequence server 18 to synchronize, or “gate”, the performance of the scan with the subject's respiration or heart beat.

The pulse sequence server 18 also connects to a scan room interface circuit 38 which receives signals from various sensors associated with the condition of the patient and the magnet system. It is also through the scan room interface circuit 38 that a patient positioning system 40 receives commands to move the patient to desired positions during the scan.

The digitized NMR signal samples produced by the RF system 26 are received by the data acquisition server 20. The data acquisition server 20 operates in response to instructions downloaded from the workstation 10 to receive the real-time NMR data and provide buffer storage such that no data is lost by data overrun. In some scans the data acquisition server 20 does little more than pass the acquired NMR data to the data processor server 22. However, in scans which require information derived from acquired NMR data to control the further performance of the scan, the data acquisition server 20 is programmed to produce such information and convey it to the pulse sequence server 18. For example, during prescans NMR data is acquired and used to calibrate the pulse sequence performed by the pulse sequence server 18. Also, navigator signals are acquired during the scan and used to adjust RF or gradient system operating parameters or to control the view order in which k-space is sampled. And, the data acquisition server 20 may be employed to process NMR signals used to detect the arrival of contrast agent in an MRA scan. In all these examples the data acquisition server 20 acquires NMR data and processes it in real-time to produce information which is used to control the scan. As will be described below, the data acquisition server 20 processes navigator signals produced during the scan and conveys information to the PET scanner which indicates the current position of the subject in the scanner.

The data processing server 22 receives NMR data from the data acquisition server 20 and processes it in accordance with instructions downloaded from the workstation 10. Such processing may include, for example: Fourier transformation of raw k-space NMR data to produce two or three-dimensional images; the application of filters to a reconstructed image; the performance of a backprojection image reconstruction of acquired NMR data; the calculation of functional MR images; the calculation of motion or flow images, etc.

Images reconstructed by the data processing server 22 are conveyed back to the workstation 10 where they are stored. Real-time images are stored in a data base memory cache (not shown) from which they may be output to operator display 12 or a display 42 which is located near the magnet assembly 30 for use by attending physicians. Batch mode images or selected real time images are stored in a host database on disc storage 44. When such images have been reconstructed and transferred to storage, the data processing server 22 notifies the data store server 23 on the workstation 10. The workstation 10 may be used by an operator to archive the images, produce films, or send the images via a network to other facilities.

The MRI system is used according to the present invention to acquire image data that is used to produce a PET attenuation correction sinogram for the PET scanner. The particular image data that is acquired will depend on the particular anatomy being imaged and on the degree of attenuation correction accuracy that is required. For example, when performing a PET scan of the head and brain MRI images may be acquired which enable the following to be differentiated: bone, air, fat, skin, muscle, cerebrospinal fluid, gray matter, white matter, blood, or meninges. A highly accurate correction might require differentiation of all these structures whereas a less accurate correction might be limited to bone, air, fat, and soft tissues. For example, data for the attenuation correction of bone is collected through the use of ultra short TE image acquisitions sensitive to signal from bone. Such pulse sequences allow for the ready differentiation of bone from air in MR images of the brain or body. Alternatively, or in addition, 3-D or multi-slice 2-D pulse sequences are employed to acquire a series of high resolution images that differentiate between different soft tissues. Also, signal intensity or chemical shift information can be used to differentiate between water and fat tissues, and to localize air and bone.

In an alternative embodiment, acquired anatomical MRI images in individual patients are compared and registered to established anatomical atlases. For example, when the subject is the brain the acquired MRI images can be registered to an anatomical atlas, such as a Talairach coordinate space. The registration of a set of anatomical images to an anatomical atlas is a technique well known to those skilled in the art. PET attenuation values are then obtained from these established atlas data and are then mapped upon the MRI images.

It is contemplated, however, that during most PET scans using the combined PET/MRI system the prescribed MRI or MRS data being acquired as part of the examination may be used to calculate the attenuation correction sinogram. For example, physiological and anatomical information is often acquired with the MRI system and used in combination with the functional information acquired simultaneously by the PET scanner to make a diagnosis of a disease. In such case the acquired MRI data may be sufficient in itself to differentiate tissue types to a degree needed to produce an acceptable PET attenuation correction sinogram. In such cases additional MR images may be acquired to supplement the clinical data that is acquired and this data can be acquired during, before, or after the PET scan. For example, an image can be acquired which enables the segmentation of bone as described in U.S. Pat. No. 6,879,156.

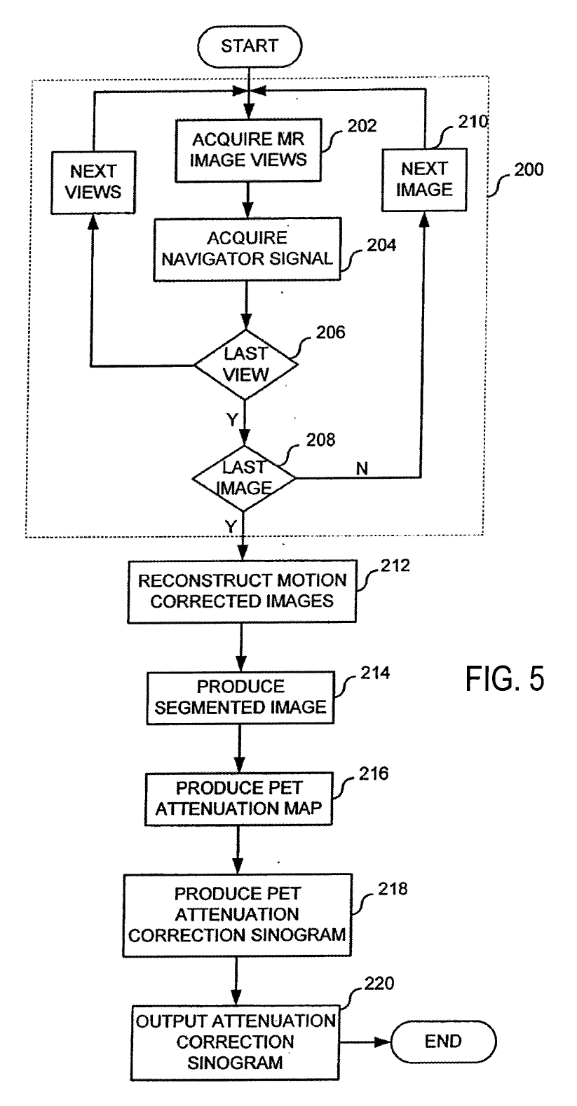

Referring particularly to FIG. 5, in the preferred embodiment the MRI data needed for the attenuation correction is acquired as part of the MRI acquisition performed during the PET scan and indicated generally by dotted line 200. Data acquisition is an iterative process in which a set of views are acquired using a prescribed pulse sequence as indicated at process block 202 and then a navigator signal is acquired at process block 204. The navigator signal is acquired with a pulse sequence such as that described in U.S. Pat. No. 5,539,312 to detect subject movement away from a reference position. This motion information is used to correct the acquired image data for subject motion, and as described in co-pending US provisional application entitled “Motion Correction Of PET Image Using Navigator Data Acquired With An MRI System”, the same navigator signal information may be used to correct the PET image for subject motion. Views are acquired until all the views for one image are acquired as determined at decision block 206.

If further images are to be acquired as determined at decision block 208, a different pulse sequence prescription is downloaded to the pulse sequence server 18 as indicated at process block 210. The views for the prescribed additional image are acquired as before and the process repeats until all the needed MR images are acquired.

As indicated at process block 212, each of the acquired images are then reconstructed and corrected for motion in a standard fashion. Some or all of these images may be further processed and used for clinical purposes, but for the purpose of the present invention, information from one or more of the reconstructed images is used to produce a segmented image as indicated at process block 214. Segmentation of MR images to define the boundaries of different tissue types is well known and the particular method depends on the particular tissue types being differentiated. For example, an automatic method for segmentation such as the method disclosed in U.S. Pat. No. 6,249,594 may be employed.

The segmented image identifies the tissue type (plus air) of each voxel in the field of view of the MRI system and the PET scanner. As indicated at process block 216, a PET attenuation map is produced next by assigning a known 511 keV attenuation value to each voxel in the field of view. For example, the known attenuation of a 511 keV proton through a bone voxel is stored at locations in the attenuation map that correspond to bone in the segmented image. This is repeated for the voxels in each of the other segmented tissue types. In addition, an attenuation value is entered for each voxel in the segmented image identified as air.

As indicated at process block 218, the next step is to produce a PET attenuation correction sinogram. As will be described below, the PET scanner produces a sinogram that contains the number of counted positron emission events at each PET line of response (LOR) through its field of view. These LORs are identified by their angle (θ) and their distance (R) from the center of the field of view. The PET sinogram arranges the detected counts in a θ by R array. The attenuation correction sinogram is calculated by forward projecting the attenuation values along each LOR (R, θ) in the PET attenuation map and storing the result at a corresponding R, θ location in the attenuation correction sinogram. This is simply the sum of all the voxel attenuation values disposed along an LOR. The attenuation correction sinogram thus stores the total attenuation a photon will see when traveling along any of the LORs (R, θ) in the scanner's field of view. This attenuation correction sinogram is output to the PET scanner as indicated at process block 220 and used by the PET scanner as described below to correct its reconstructed image.

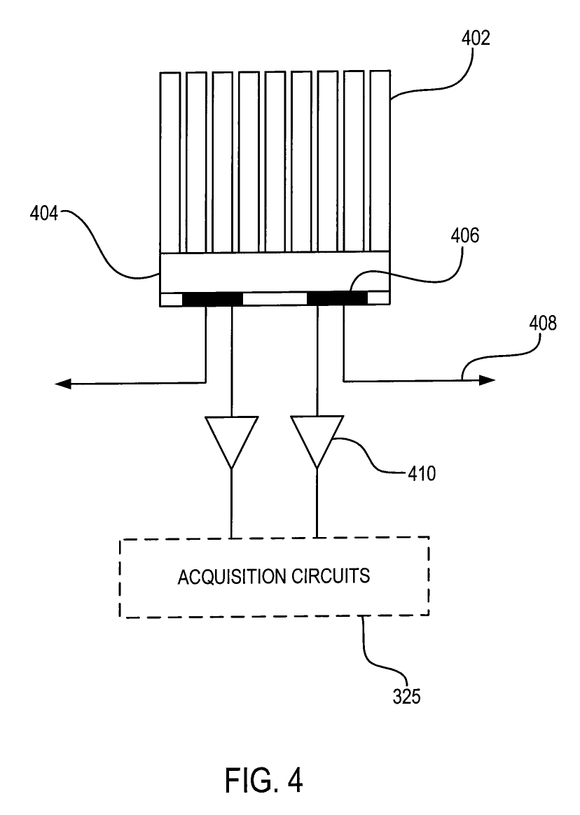

Referring particularly to FIG. 2, the PET scanner system includes the gantry 370 which supports the detector ring assembly 372 within the cylindrical bore of the general magnet assembly 30. The detector ring 372 is comprised of detector units 320, which are shown in more detail in FIG. 4. As shown in FIG. 4, the PET detector units 320 include an array of scintillator crystals 402 that are optically coupled through a light guide 404 to a solid state photodetector 406, such as an avalanche photodiode (APD). The scintillators 402 can either be coupled one-to-one with a photodetector 406, or a plurality of scintillators 402 can be coupled to a single photodetector 406. Each photodetector 406 is electrically connected to a high voltage source through an electrical connection 408. A single high voltage source can be connected to a plurality of photodetectors 406 in this manner. The charge created in the photodetectors 406 is collected in a preamplifier 410. The signals produced by the preamplifiers 410 are then received by a set of acquisition circuits 325 which produce digital signals indicating the event coordinates (x, y) and the total energy. Referring now to FIG. 2, these signals are sent through a cable 326 to an event locator circuit 327 housed in a separate cabinet. Each acquisition circuit 325 also produces an event detection pulse (EDP) which indicates the exact moment the scintillation event took place.

The event locator circuits 327 form part of a data acquisition processor 330 which periodically samples the signals produced by the acquisition circuits 325. The processor 330 has an acquisition CPU 329 which controls communications on local area network 318 and a backplane bus 331. The event locator circuits 327 assemble the information regarding each valid event into a set of digital numbers that indicate precisely when the event took place and the position of the scintillator crystal which detected the event. This event data packet is conveyed to a coincidence detector 332 which is also part of the data acquisition processor 330.

The coincidence detector 332 accepts the event data packets from the event locators 327 and determines if any two of them are in coincidence. Coincidence is determined by a number of factors. First, the time markers in each event data packet must be within a preset time of each other, and second, the locations indicated by the two event data packets must lie on a straight line which passes through the field of view (FOV) in the bore of the magnet assembly 30. Events which cannot be paired are discarded, but coincident event pairs are located and recorded as a coincidence data packet.

As described in the above-cited copending provisional application, the coincidence data packets can be corrected for subject motion during the scan using the navigator signals that are periodically acquired. The coincidence data packets are saved until a set of corrective values are received from the MRI system which reflect the current position of the subject. Using this corrective information and the information in each coincidence data packet, a corresponding set of corrected coincidence data packets is calculated. Each coincidence data packet is thus corrected to change its projection ray, (R, θ) by an amount corresponding to the movement of the subject away from the reference position. These motion corrections insure that the PET attenuation correction sinogram described above is registered with the sinogram produced by the PET scanner described below.

The motion corrected coincidence data packets are conveyed through a serial link 333 to a sorter 334 where they are used to form a sinogram. The sorter 334 forms part of an image reconstruction processor 340. The sorter 334 counts all events occurring along each projection ray (R, θ) and organizes them into a two dimensional sinogram array 348 which is stored in a memory module 343. In other words, a count at sinogram location (R, θ) is increased each time a corrected coincidence data packet along that LOR is received. The image reconstruction processor 340 also includes an image CPU 342 that controls a backplane bus 341 and links it to the local area network 318. An array processor 345 connects to the backplane bus 341 and it reconstructs an image from the sinogram array 348. This is a conventional PET image reconstruction except that it uses the attenuation sinogram produced by the MRI system to make the necessary attenuation corrections. Attenuation corrections can be performed, for example, by multiplying each LOR in the sinogram array 348 by a corresponding attenuation correction factor calculated from the attenuation sinogram. In this method, attenuation correction factors for each LOR are determined by numerically integrating the attenuation coefficients in the attenuation sinogram along that LOR. The resulting image array 346 is stored in memory module 343 and is output by the image CPU 342 to the operator work station 315.

The operator work station 315 includes a CPU 350, a CRT display 351 and a keyboard 352. The CPU 350 connects to the local area network 318 and it scans the keyboard 352 for input information. Through the keyboard 352 and associated control panel switches, the operator can control the calibration of the PET scanner and its configuration. Similarly, the operator can control the display of the resulting image on the CRT display 351 and perform image enhancement functions using programs executed by the work station CPU 350.

It can be appreciated by those skilled in the art that many variations can be made from the preferred embodiment without departing from the spirit of the invention. For example, the MRI system and PET scanner may be more fully integrated with control and processing components being shared by both systems. Alternatively, the PET system might be physically contiguous with the MRI scanner but not situated within it. Furthermore, the MRI data used for attenuation correction may be acquired before or after the PET scan.

1. A method for correcting the attenuation of a positron emission tomography (PET) image in a combination PET and magnetic resonance imaging (MRI) system, the steps comprising:
a) positioning the subject to be imaged within a field of view of the PET scanner and the MRI system;
b) acquiring with the PET scanner sinogram data that counts the number of coincidence events at a plurality of lines of response;
c) acquiring with the MRI scanner image data of the subject;
d) producing from the acquired image data an attenuation correction sinogram in which the attenuation of a photon traveling along each of the lines of response is indicated; and
e) reconstructing a PET image using the acquired sinogram data and the attenuation correction sinogram data.

2. The method as recited in claim 1 in which the attenuation correction sinogram is produced in step d) by:
reconstructing an image from the acquired image data;
producing a segmented image from the reconstructed image that indicates the tissue type of each voxel in the field of view;
producing an attenuation map by setting each voxel in the field of view to an attenuation value corresponding to the tissue type at that voxel indicated by the segmented image; and
producing the attenuation correction sinogram by forward projecting the attenuation map along each line of response.

3. The method as recited in claim 1 in which steps b) and c) are performed substantially concurrently.

4. The method as recited in claim 2 in which step c) is performed using a pulse sequence that directs the MRI system to acquire image data that differentiates between selected tissue types in the field of view.

5. The method as recited in claim 4 in which a plurality of different pulse sequences are employed to differentiate between a plurality of different tissue types.

6. A method for correcting the attenuation of a positron emission tomography (PET) image in a combination PET and magnetic resonance imaging (MRI) system, the steps comprising:
a) positioning the subject to be imaged within a field of view of the PET scanner and the MRI system;
b) acquiring with the PET scanner data that counts the number of coincidence events at a plurality of lines of response;
c) acquiring with the MRI scanner image data of the subject;
d) producing from the acquired image data an attenuation correction data set in which the attenuation of a photon traveling along each of the lines of response is indicated; and
e) reconstructing a PET image using the acquired PET scanner data and the attenuation correction data set.

7. The method as recited in claim 6 in which the attenuation correction data set is produced in step d) by:
reconstructing an image from the acquired image data;
registering the reconstructed image to an anatomical atlas that indicates the tissue type of each voxel in the field of view; and
setting each voxel in the attenuation correction data set to an attenuation value corresponding to the tissue type at that voxel indicated by the anatomical atlas.

8. The method as recited in claim 6 in which steps b) and c) are performed substantially concurrently.
